(19) United States
(12) Patent Application Publication
(10) Pub. No.: US 2025/0111388 A1
(43) Pub. Date: Apr. 3, 2025

(54) SYSTEM AND METHOD FOR IMPLEMENTING AN OPPORTUNITY VALUE TOOL

(71) Applicant: KPMG LLP, New York, NY (US)

(72) Inventors: Sanjay Sehgal, Potomac, MD (US); Martin Roldan Auffant, Tampa, FL (US); Htike Htike Kyaw Soe, Great Neck, NY (US); Yavin Muller, Rye Brook, NY (US)

(21) Appl. No.: 18/901,299

(22) Filed: Sep. 30, 2024

Related U.S. Application Data
(60) Provisional application No. 63/540,996, filed on Sep. 28, 2023.

(51) Int. Cl. G06Q 30/0201

(52) U.S. Cl. CPC G06Q 30/0201

(57) ABSTRACT

An embodiment of the present invention is directed to an Opportunity Value Tool that applies a data-driven approach to identify profit and working capital improvement opportunities. For example, the Opportunity Value Tool may identify new client opportunities by enabling more value improvement engagement opportunities from a deal pipeline. The Opportunity Value Tool may further support discovery of companies with improvement opportunities to generate quality leads. In addition, quantifiable improvement opportunities may drive first client conversations through value add insights. Other scenarios, applications and use cases may be realized.

### CROSS-REFERENCE TO RELATED APPLICATIONS

The application claims priority to U.S. Provisional Application No. 63/540,996 (Attorney Docket No. 055089.0000119), filed Sep. 28, 2023, the contents of which are incorporated by reference herein in their entirety.

### FIELD OF THE INVENTION

The present invention relates to systems and methods for implementing an opportunity value tool.

### BACKGROUND

Service providers are seeking ways to better address client needs. While there are enormous amounts of data available (proprietary and public), it is difficult and challenging to identify opportunities to address client needs at the right time with the right team. This is particularly problematic in the deal context where information needs to be analyzed quickly and opportunities need to be identified in a matter of days if not hours.

It would be desirable, therefore, to have a system and method that could overcome the foregoing disadvantages of known systems.

### SUMMARY

According to an embodiment, the invention relates to a computer-implemented system that implements an opportunity value tool. The system comprises: an input configured to access one or more data sources that store and manage target proprietary financial data and public data; an interactive user interface that communicates with one or more user devices via a communication network; and a computer processor coupled to the input, the interactive user interface and the one or more data sources, the computer processor further configured to: identify, via the computer processor, a target entity; perform, via the computer processor, a peer selection for the target entity by applying an optimal set of filters comprising industry, geographic region, time period, revenue, and EBITDA margin; generate, via the computer processor, a target summary comprising at least a profit improvement opportunity and a working capital opportunity; generate, via the computer processor, the profit improvement opportunity comprising analytics by EBITDA, cost of goods sold (COGS) and selling, general and administrative expenses (SG&A); generate, via the computer processor, the working capital opportunity comprising analytics by Days Sales Outstanding (DSO), Days Payables Outstanding (DPO) and Days of Inventory Outstanding (DIO); generate, via the computer processor, an opportunity strategy for the profit improvement opportunity and the working capital opportunity; and execute, via the computer processor, the opportunity strategy for the target entity.

According to another embodiment, the invention also relates to a computer-implemented method that implements an opportunity value tool. The method comprises the steps of: identifying, via a computer processor, a target entity; performing, via the computer processor, a peer selection for the target entity by applying an optimal set of filters comprising industry, geographic region, time period, revenue, and EBITDA margin; generating, via the computer processor, a target summary comprising at least a profit improvement opportunity and a working capital opportunity; generating, via the computer processor, the profit improvement opportunity comprising analytics by EBITDA, cost of goods sold (COGS) and selling, general and administrative expenses (SG&A); generating, via the computer processor, the working capital opportunity comprising analytics by Days Sales Outstanding (DSO), Days Payables Outstanding (DPO) and Days of Inventory Outstanding (DIO); generating, via the computer processor, an opportunity strategy for the profit improvement opportunity and the working capital opportunity; and executing, via the computer processor, the opportunity strategy for the target entity.

According to yet another embodiment, the invention relates to a computer-readable medium containing program instructions for executing a method for implementing an opportunity value tool.

An embodiment of the present invention leverages client specific data (e.g., public as well as proprietary) to answer and address specific client opportunity requests. An embodiment of the present invention is directed to identifying an opportunity for profit improvement (e.g., cost savings) as well as working capital (WC) improvement. The innovative system quantifies the identified opportunity (e.g., dollar amount, percentage, etc.) and develops a strategy that engagement teams may then execute with the target client.

An embodiment of the present invention may support various use cases, applications and industries. Exemplary scenarios may include in a deal context, client connections and client targeting.

In a deal context, a client may engage a financial due diligence (FDD) team for an upcoming deal with a target entity within days or a week. An embodiment of the present invention may perform deal analysis by developing a strategy by investigating potential problem areas and quantifying them and further identifying relevant strategy partners and leads. Because of the fast nature in a deal context, an embodiment of the present invention focuses on speed and immediate turnaround time. An embodiment of the present invention is further focused on preserving client confidential information with no/minimal leakage.

In a client connection context, an entity may have a meeting with a client and use an embodiment of the present invention to focus the meeting and strategically identify relevant team members. For example, an embodiment of the present invention may identify inventory problems and provide supporting information to better focus the client meeting.

In a client targeting context, an embodiment of the present invention may identify clients with potential opportunities, such as inventory issues, etc. Opportunities may be identified by analyzing factors relating to: Selling, General and Administrative Expenses (SG&A), cost of goods sold (COGS) and working capital. The opportunity may be quantified in dollar amounts as well as percentages to determine whether the opportunity is worth investigating.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates an exemplary data pipeline, according to an embodiment of the present invention.

FIG. 2 is an exemplary system diagram implementing an Opportunity Value Tool, according to an embodiment of the present invention.

FIG. 3 is an exemplary interface that illustrates Peer Selection, according to an embodiment of the present invention.

FIG. 4 is an exemplary interface that illustrates an Opportunity Summary, according to an embodiment of the present invention.

FIG. 5 is an exemplary interface that illustrates Profit Improvement Opportunity, according to an embodiment of the present invention.

FIG. 6 is an exemplary interface that illustrates COGS Opportunity, according to an embodiment of the present invention.

FIG. 7 is an exemplary interface that illustrates Working Capital Opportunity, according to an embodiment of the present invention.

FIG. 8 is an exemplary interface that illustrates Working Capital Summary, according to an embodiment of the present invention.

FIG. 9 is an exemplary interface that illustrates DPO Opportunity, according to an embodiment of the present invention.

FIG. 10 is an example of an external opportunity summary, according to an embodiment of the present invention.

FIG. 11 is an example of an internal opportunity summary, according to an embodiment of the present invention.

FIG. 12 illustrates opportunity area examples, according to an embodiment of the present invention.

FIG. 13 is an exemplary process flow, according to an embodiment of the present invention.

FIG. 14 is an exemplary process flow, according to an embodiment of the present invention.

FIG. 15 is an exemplary process flow, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to an Opportunity Value Tool (OVT) that applies a data-driven approach to identify profit and working capital improvement opportunities. For example, the Opportunity Value Tool may identify new client opportunities by generating value improvement engagement opportunities from a deal pipeline. The Opportunity Value Tool may further support discovery of companies with improvement opportunities to generate quality leads. In addition, quantifiable improvement opportunities may drive first client conversations through value added insights. Other scenarios, applications and use cases may be realized.

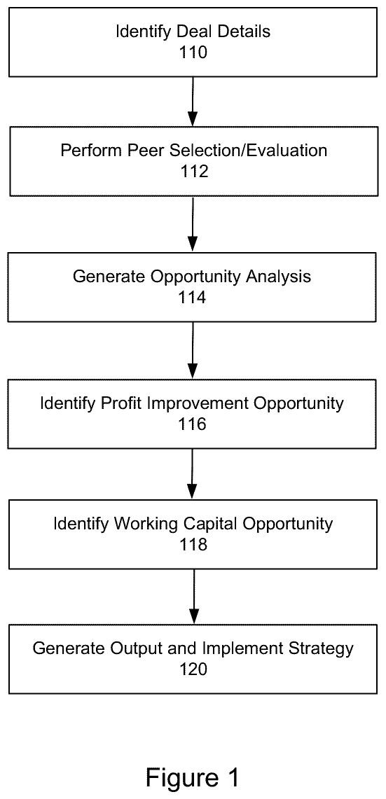

FIG. 1 illustrates an exemplary data pipeline, according to an embodiment of the present invention. At step 110, deal details may be identified and processed to identify opportunities. At step 112, peer selection and evaluation may be performed. At step 114, opportunity analysis may be generated. At step 116, specific profit improvement opportunities may be identified. At step 118, specific working capital opportunities may be identified. At step 120, an output may be generated with a corresponding strategy for implementation. While the process of FIG. 1 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 110, deal details may be identified. For example, a deal may be identified in three exemplary lines of defense, from pre-engagement to shortly after the start of engagement. This may include: (1) engaging in a non-confidential deal identified by target name and requesting CIM/sell side pack for OVT; (2) notifying OES (Operations Engagement Setup) team of deal and target name and CIM/sell side pack requested for OVT and (3) providing FPI trial balance data for OVT. Minimum deal size and priority industry criteria may be applied. CIM represents Confidential Information Memorandum, e.g., target summary provided by the seller's bankers in a transaction. FPI represents Financial Profitability Insights, e.g., a tool used by a Financial Due Diligence team to summarize trial balance data.

For example, a deal may be identified by a FDD (Financial Due Diligence) team. Deal details may be analyzed for risk control purposes and may include: confidential information that describes targets and corresponding financial details. Automation may be applied to accessing a data source and retrieving this information. Opportunity criteria may be applied, such as minimum deal size and priority industry, e.g., manufacturing, life sciences, financial services, etc.

Data may be processed to identify opportunities. This may involve: (1) expedited data processing that enables being able to share reports within 24 to 48 hours; (2) excluding data from an overall benchmarking population until after engagement is done and Standard Terms and Conditions (ST&C) have been verified. In addition, requests may be sent to a benchmarking team as well as other recipients.

At step 112, peer selection and evaluation may be performed. An embodiment of the present invention is directed to accurately and intelligently identifying a set of peers for a target entity based on a balance of various factors including Industry, Geographic Region, Time Period (e.g., Year), Revenue, EBITDA (earnings before interest, taxes, depreciation, and amortization) margin, peer list, etc. Peer selection may be further refined and iterated on through additional metrics and financial parameters. An embodiment of the present invention may rely on AI/ML algorithms to accurately identify and refine peer selection. For example, a peer selection process may suggest recommended peers for a company using a combination of defined logic (that may apply a set of filters and constraints such as revenue, EBITDA, industry, geography, etc.), third party datasets and LLM suggestions. Additional filters may be applied to the recommended peers.

At step 114, opportunity analysis may be generated. This may involve generating an opportunity value report. For example, a benchmarking team may generate an OVT report and dashboard. A report may be generated when there is adequate data and peer selection. Target name and other sensitive data may be kept confidential and only made known to the individuals working on the data and report.

An embodiment of the present invention is directed to quantifying and evaluating specific tailored opportunities that are generally not measurable or even ascertainable with current systems and methods. An embodiment of the present invention provides a data-driven approach to accurately quantify and calculate profit and working capital improvement opportunities that is not available with traditional approaches. An embodiment of the present invention may leverage AI/ML techniques to train data from prior engagements and outcomes in a manner that accurately optimizes a set of parameters for peer selection and opportunity generation specific to profit improvement and working capital.

At step 116, specific profit improvement opportunities may be identified. Profit improvement opportunities may be based on a combination of specific metrics including EBITDA, COGS and SG&A with peer selection at various levels of COGS and SG&A.

At step 118, specific working capital opportunities may be identified. Working capital opportunities may be evaluated by DSO, DPO and DIO.

At step 120, an output may be generated with a corresponding strategy or optimization plan for implementation. In a deal context, the output may be shared within 24 to 48 hours. In this example, an output report may be distributed to an associated FDD partner and relevant Strategy lead. For example, the Strategy lead may share with an appropriate Strategy partner to continue conversations with the FDD team and client. For a PE (private equity) client, this may include a Strategy PE lead with a Strategy Industry lead. For a Corporate client, this may include a Strategy industry lead. The Report name may not reveal client or target name. In cases of conflict (e.g., same target multiple clients), conflict may be flagged so Strategy lead can work with resource management to avoid conflicts.

In accordance with the various embodiments of the present invention, FIG. 1 may be modified to support a wide range of uses and applications.

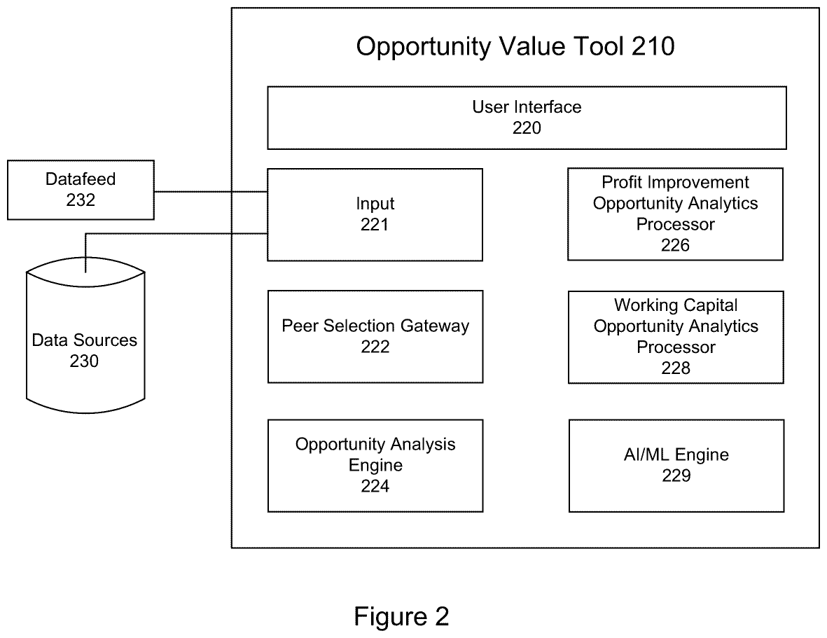

FIG. 2 is an exemplary system diagram implementing an Opportunity Value Tool, according to an embodiment of the present invention. Opportunity Value Tool 210 may include Interface 220 that supports various user interfaces to communicate opportunity details. Interface 220 may be tailored to specific use cases, applications, industries, etc.

Input 221 may access data sources represented by 230 including data feeds represented by 232 from internal and external sources. Input 221 may access data relating to public and private companies as well as confidential proprietary information, e.g., prior engagements, engagement data, performance data, metrics, analytics, etc.

Peer Selection Gateway 222 provides peer selection for a specific company or discovery of companies with opportunity. Peer selection may consider various metrics including industry, geographic region, time period (e.g., year), revenue, EBITDA margin, peer data, etc. An embodiment of the present invention may seek to optimize a combination of various metrics to accurately identify relevant peers for analysis, benchmarking and comparison. For example, a peer selection process may suggest recommended peers for a company using a combination of defined logic, third party datasets and LLM suggestions. In addition, filters may be applied to the recommended peers as needed or desired.

Opportunity Analysis Engine 224 may present summary and analysis for a selected company along with profit and working capital improvement opportunities. Working capital represents current assets minus current liabilities and generally represents operating liquidity available to a business.

Profit Improvement Opportunity Analytics Processor 226 provides profitability breakdown by EBITDA, cost of goods sold (COGS) and selling, general and administrative expenses (SG&A). Opportunity insights may be based on Peer selection at various levels of COGS and S&GA. EBITDA may refer to earnings before interest, taxes, depreciation and amortization and represents a company's overall financial performance. COGS may refer to direct costs associated with making a product and provides business insight into a company's performance and profit. SG&A refers to expenses that relate to overhead costs of doing business.

Working Capital Opportunity Analytics Processor 228 provides working capital overview and opportunities in Days Sales Outstanding (DSO), Days Payables Outstanding (DPO) and Days of Inventory Outstanding (DIO). Generally, DIO and DSO correlate to a company's cash inflow while DPO represents cash outflows.

AI/ML Engine 229 may integrate artificial intelligence and machine learning algorithms to analyze training data from prior engagements, results from client interactions and other analytics to develop models that refine and improve on peer selection and opportunity analysis including profit improvement and working capital opportunities. AI/ML 229 may apply various neural networks and algorithms to recognize patterns/classifications that may be applied to generate and refine potential opportunities as well as identify targeted and timely client interaction opportunities. AI/ML Engine 229 may support various neural networks that recognize relationships between one or more variables. Other networks and models may be supported.

According to an embodiment of the present invention, an Opportunity Value Tool represents a business enablement tool that identifies profit improvement and working capital optimization opportunities among public, private and proprietary companies. The Opportunity Value Tool enables users to: find opportunities for a specific company and discover companies with opportunities.

According to an embodiment of the present invention, an opportunity may represent profit improvement/cost savings and working capital optimization possibilities within a selected target company. This may represent a value determined by taking a difference between targeted company's value and median value. For example, if a target is underperforming compared to the median of the selected peers, an opportunity may be identified. For example, SG&A expenses of a target may be determined to be higher than the median value, meaning there is potential for saving those costs.

The Opportunity Value Tool may access various data sources (as shown by 230) including data relating to public and private companies with public debt, as well as proprietary companies hosted on an entity's product. Public and private companies may be sourced from S&P Capital IQ through a datafeed (as shown by 232), and proprietary data may be processed and ingested from past engagement reports as well as other sources of prior interactions and metrics. Other sources of data may be accessed.

According to an embodiment of the present invention, a company may be selected for evaluation for an opportunity. The company may be referred to as “Company Targeted” which may then be evaluated against a set of peers selected through a combination of filters applied in “Select Criteria for Peer Identification.” Based on the position of the target performance as compared to a median or Top quartile of the selected peer set, an opportunity with respect to profit improvement or working capital optimization may be determined.

Peer selection, provided by Peer Selection Gateway 222, may apply an optimal combination of filters to the peers against factors to evaluate a target company. Factors may include: Industry, Geographic Regions, Year, Revenue, EBITDA margin, peer list, etc. Industry may involve selecting industry taxonomies that are relevant and comparable to target company. Geographic Regions may involve selecting comparable geographic regions or country with respect to target company selected. Year may represent a time period range, e.g., range of years to generate a benchmark for the comparable peers. For example, based on the year selected, a value for each peer for the latest available period within the period range may be selected. Revenue may involve selecting a revenue range of comparable peers to benchmark against. EBITDA Margin may involve selecting an EBITDA Margin % range of comparable peers to benchmark against. Peer list may involve selecting a list of peers.

An Opportunity Summary view, provided by Opportunity Analysis Engine 224, may summarize an overall opportunity (e.g., base opportunity in comparison to median of peers) which may include: a Profit improvement opportunity and Total Working Capital Optimization Opportunity, along with further breakdown of profit improvement opportunity into COGS & SG&A opportunity and Working capital optimization opportunity by Days Sales Outstanding (DSO), Days Inventory Outstanding (DIO) and Days Payable Outstanding (DPO). The Opportunity Summary may also provide an overview of the target performance including Revenues, EBITDA, Revenue growth %, Profit improvement % (Profit improvement opportunity as % of Total cost), WC Improvement % (WC Improvement opportunity as % of Accounts receivables+Inventory−Accounts Receivables) and business description.

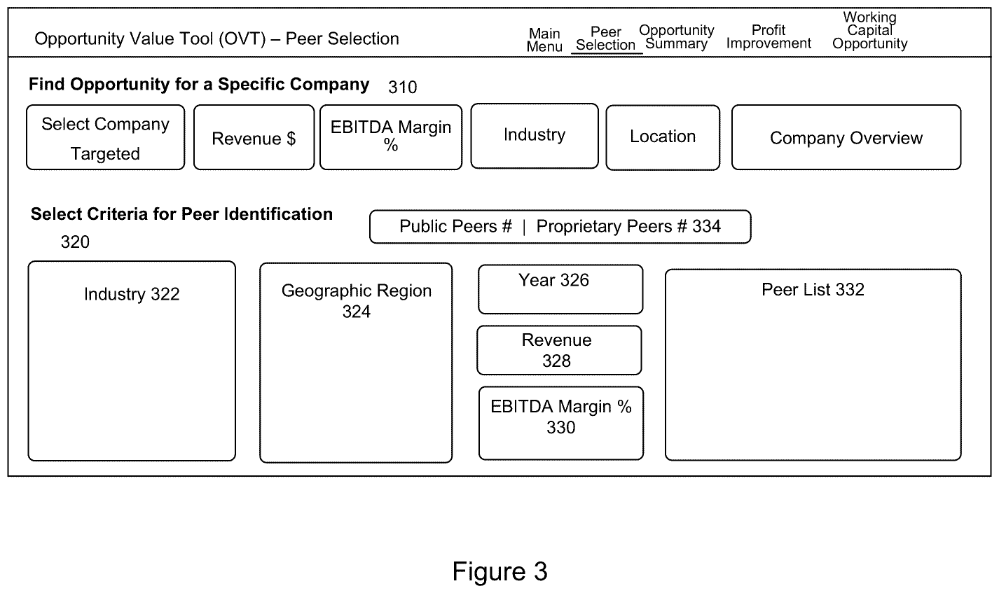

FIG. 3 is an exemplary interface that illustrates Peer Selection, according to an embodiment of the present invention. As shown by 310, Target company analytics may include: Revenue, EBITDA Margin, Industry, Location and Company Overview. Peer selection criteria 320 may include: Industry 322, Geographic Region 324, Time Period 326 (e.g., Year), Revenue 328, EBITDA Margin 330 and Peer Listing 332. A count of Public Peers and Proprietary Peers may be provided at 334.

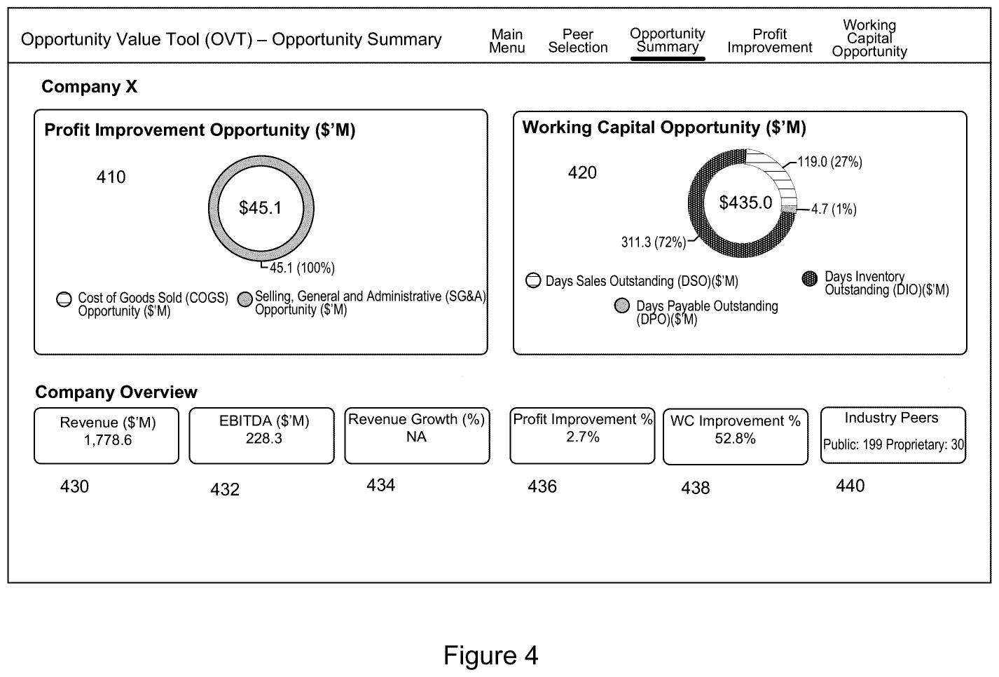

FIG. 4 is an exemplary interface that illustrates an Opportunity Summary, according to an embodiment of the present invention. As shown in FIG. 4, Profit Improvement Opportunity 410 and Working Capital Opportunity 420 may be illustrated. Profit Improvement Opportunity 410 illustrates COGS and SG&A details. Working Capital Opportunity 420 provides DSO, DIO and DPO details. Company Overview data may be illustrated by Revenue 430, EBITDA 432, Revenue Growth 434, Profit Improvement 436, WC Improvement 438 and Industry Peers 440.

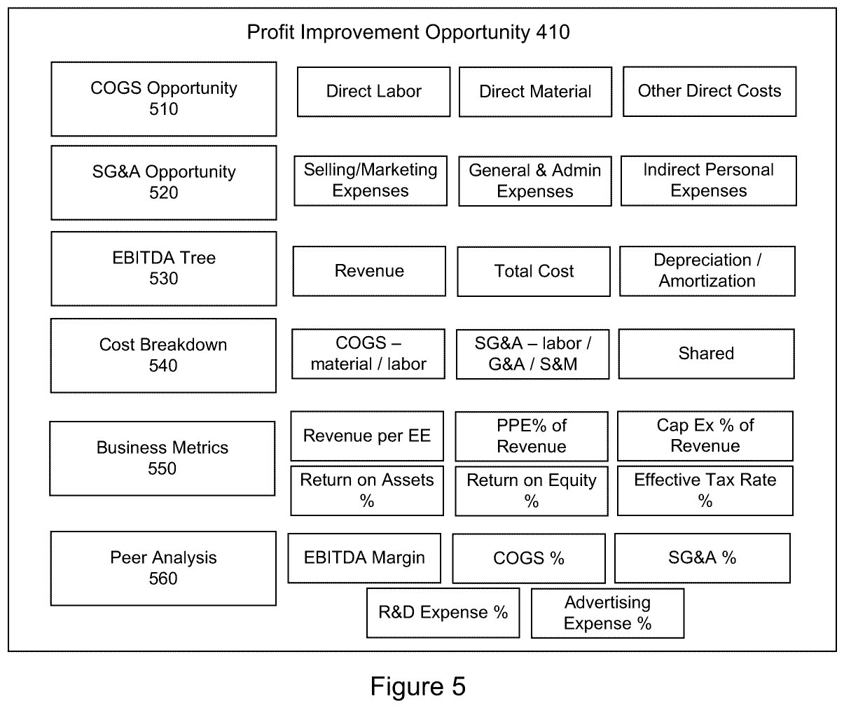

FIG. 5 is an exemplary interface that illustrates Profit Improvement Opportunity, according to an embodiment of the present invention. Profit Improvement Opportunity may showcase details around an opportunity associated with a target company's profit improvement/cost saving. Profit Improvement Opportunity 410 may include COGS Opportunity 510, SG&A Opportunity 520, EBITDA Tree 530, Cost Breakdown 540, Business Metrics 550 and Peer Analysis 560.

COGS Opportunity 510 may provide details relating to Direct Labor, Direct.

Material, and Other Direct Costs. COGS Opportunity 510 may showcase an evaluation of profit improvement opportunity associated with targeted company's direct costs. For example, a comparison may be between targeted company's COGS ($ as well as %) vs. median and top quartile of the selected comparable peers.

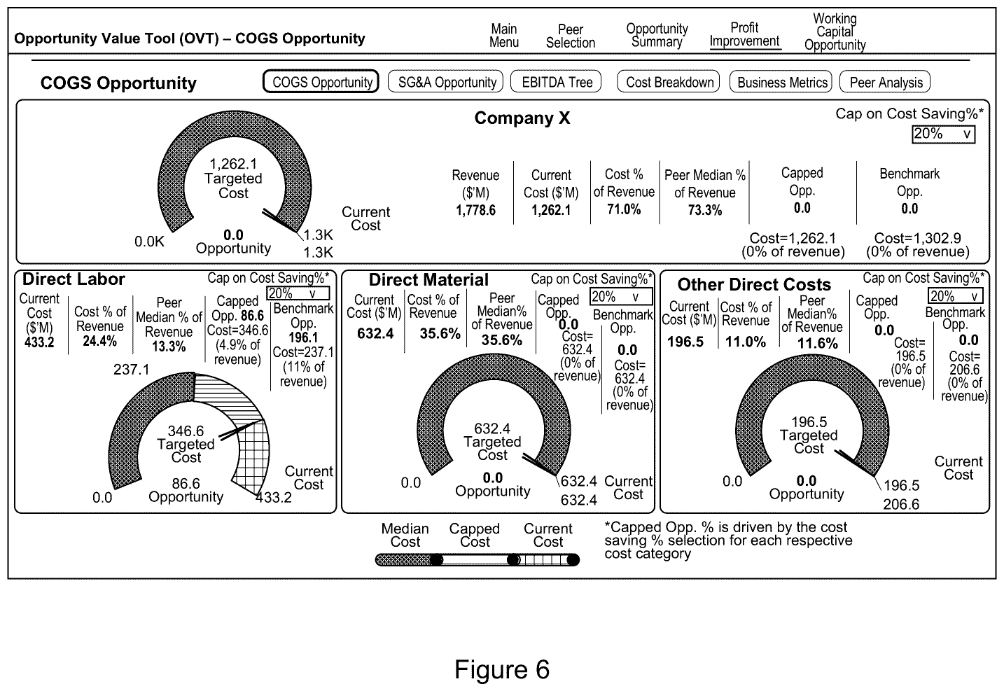

FIG. 6 is an exemplary interface that illustrates COGS Opportunity, according to an embodiment of the present invention. For Company X, data analytics relating to Revenue, Current Cost, Cost percentage of Revenue, Peer Median of Revenue, Capped Opportunity and Benchmark Opportunity may be provided. COGS details relating to Direct Labor, Direct Material and Other Direct Costs may be provided.

SG&A Opportunity 520 may provide details relating to Selling/Marketing Expenses, General and Administrative Expenses, Indirect Personal Expenses. SG&A Opportunity 520 may showcase an evaluation of the profit improvement opportunity associated with a targeted company's indirect costs, e.g., Selling general & administrative expenses. For example, a comparison may be between targeted company's SG&A ($ as well as %) vs. median and top quartile of the selected comparable peers.

EBITDA Tree 530 may showcase a selected target company's EBITDA breaking down into Revenue, Total cost and Depreciation & amortization, and then total cost further breaking down into Cost of goods sold, SG&A, research and development (R&D) expenses, and Other operating expenses. This view may showcase the trend as well as the current state of earnings vs. costs of the target company.

Cost Breakdown 540 may showcase a selected targeted company's breakdown of COGS, SG&A and Shared (between COGS & SG&A) expense over a period. For each breakdown, costs may be listed from highest spend to lowest spend basis.

Business metrics 550 may showcase a selected targeted company's key business metrics such as Revenue per employee, property plan and equipment (PPE) as % of revenue, capital expenditure (Cap Ex) as % of Revenue, Return on assets, Return on equity and Effective Tax Rate % over a period of time in comparison to the median value of selected peer set.

Peer Analysis 560 may showcase a selected targeted company's performance compared to its peers on key KPI (key performance indicator) such as EBITDA margin %, COGS as % of revenue, SG&A as % of revenue, R&D expense % and Advertising expense % over a period.

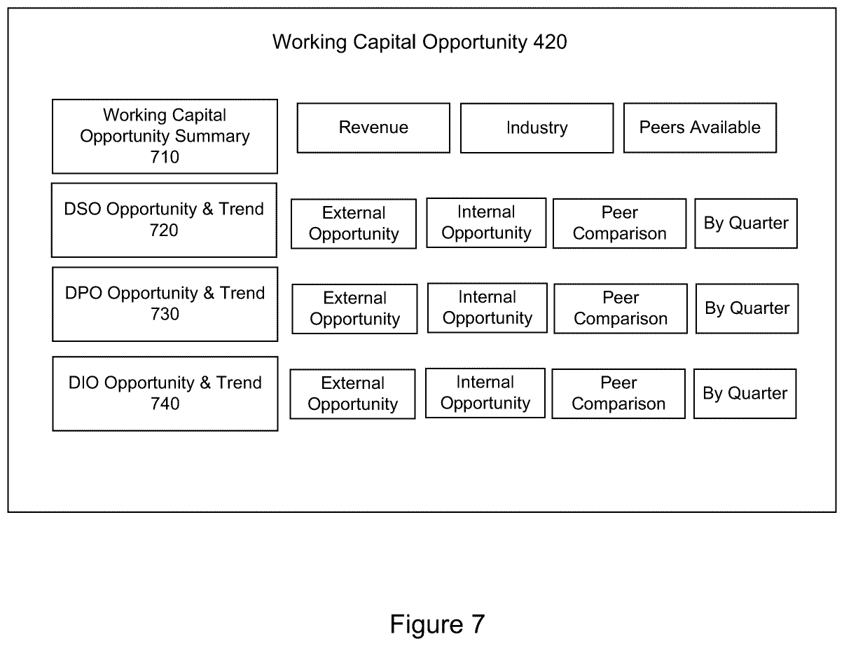

FIG. 7 is an exemplary interface that illustrates Working Capital Opportunity, according to an embodiment of the present invention. Working Capital Opportunity may highlight details around opportunities associated with optimization of a target company's working capital requirements. Working Capital Opportunity 420 may include Working Capital Opportunity Summary 710; DSO Opportunity & Trend 720; DPO Opportunity & Trend 730; and DIO Opportunity & Trend 740. Working Capital Opportunity Summary 710 may expand on Revenue, Industry and Peers Available. For DSO, DPO and DIO Opportunities, details may expand on External Opportunity, Internal Opportunity, Peer Comparison and By Quarter (or other time period).

Working Capital Opportunity Summary 710 may summarize working capital improvement opportunities for a targeted company. This view may include the details or visualizations including: Working capital opportunity evaluated on two scales e.g., Median quartile opportunity and Top quartile opportunity, which may be further broken down into DSO, DPO and DIO Company overview-Brief business description of the company; profit and loss (P&L) Metrics such as Revenue and Cost of goods sold (COGS) for last 12 months period; Balance Sheet Metrics such as Accounts receivables (AR), Accounts Payable (AP), Inventory for the last balance sheet date; and Last 4 quarters average numbers for DSO, DPO and DIO of the selected target company.

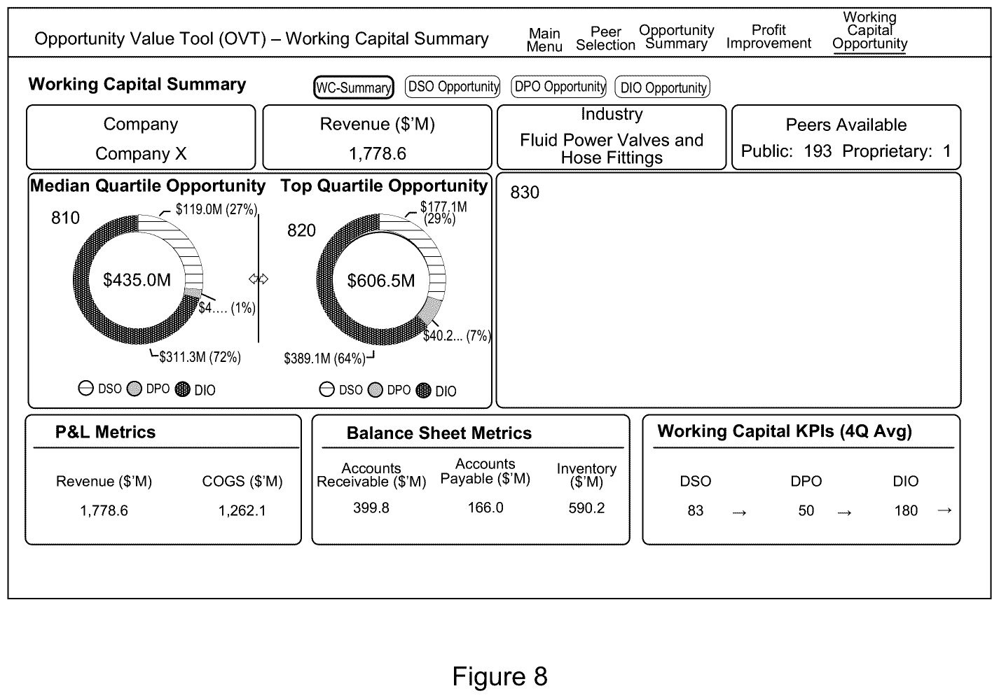

FIG. 8 is an exemplary interface that illustrates Working Capital Summary, according to an embodiment of the present invention. For a Company X, details may include Revenue; Industry; Peers available as well as Median Quartile Opportunity 810, Top Quartile Opportunity 820 and other details represented by 830. Metrics may include: P&L Metrics, Balance Sheet Metrics and Working Capital KPIs.

DSO Opportunity & Trend 720 may include details or visualizations including: Day of sale (e.g., Revenue/365); DSO (4Q Avg) (e.g., Days Sales Outstanding (4 quarters average)); Peer DSO Metrics (e.g., Median and Top Quartile of the peer set); Benchmarked Opportunity (Base & Stretch) (e.g., Opportunity evaluated based on Median and Top quartiles value of comparable peers depicting what is the least and maximum DSO optimization possibility); Internal Opportunity Historical Best (e.g., represents the maximum opportunity of working capital optimization with respect to DSO that was available with the selected target company in comparison to its current status of DSO which may be calculated by taking the difference between the latest quarter DSO and Lowest DSO in the historical period, and then multiplying the same with Day of sales (i.e., Revenue/365)); Peer Comparison (e.g., showcases the average DSO values for all the selected peers along with Top Quartile and Median value); and DSO by Quarter (e.g., showcases the trend in DSO value for selected target company vs. median of its peers over a period).

DPO Opportunity & Trend 730 may includes details or visualizations including: Day of COGS (e.g., COGS/365); DPO (4Q Avg) (e.g., Days Payable Outstanding (4 quarters average)); Peer DPO Metrics (e.g., Median and Top Quartile of the peer set); Benchmarked Opportunity (Base & Stretch) (e.g., Opportunity evaluated based on Median and Top quartiles value of comparable peers depicting what is the least and maximum DPO optimization possibility); Internal Opportunity Historical Best (e.g., represents the maximum opportunity of working capital optimization with respect to DPO that was available with the selected target company in comparison to its current status of DPO, which may be calculated by taking the difference between the latest quarter DPO and Highest DPO in the historical period, and then multiplying the same with Day of COGS); Peer Comparison (e.g., showcases the average DPO values for all the selected peers along with Top Quartile and Median value); and DPO by Quarter (e.g., showcases the trend in DPO value for selected target company over a period compared to median of its peers).

DIO Opportunity & Trend 740 may include details or visualizations including: Day of COGS (e.g., COGS/365); DIO (4Q Avg) (e.g., Days Inventory Outstanding (4 quarters average)); Peer DIO Metrics (e.g., Median and Top Quartile of the peer set); Benchmarked Opportunity (Base & Stretch) (e.g., Opportunity evaluated based on Median and Top quartiles value of comparable peers depicting what is the least and maximum DIO optimization possibility); Internal Opportunity Historical Best (e.g., represents the maximum opportunity of working capital optimization with respect to DIO that was available with the selected target company in comparison to its current status of DIO which may be calculated by taking the difference between the latest quarter DIO and lowest DIO in the historical period, and then multiplying the same with Day of COGS); Peer Comparison (e.g., showcases the average DIO values for all the selected peers along with Top Quartile and Median value); DPO by Quarter (e.g., showcases the trend in DIO value for selected target company over a period compared to median of its peers).

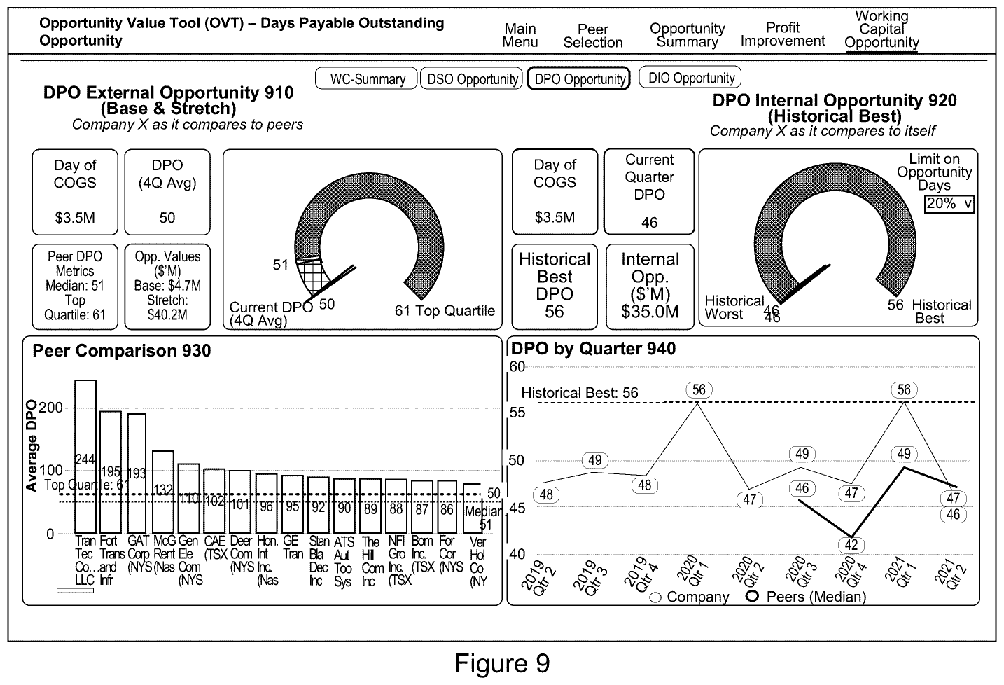

FIG. 9 is an exemplary interface that illustrates DPO Opportunity, according to an embodiment of the present invention. FIG. 9 illustrates External Opportunity 910, Internal Opportunity 920, Peer Comparison 930 and DPO by Quarter 940. FIG. 9 may be further expanded to support DSO and DIO as well as other variations.

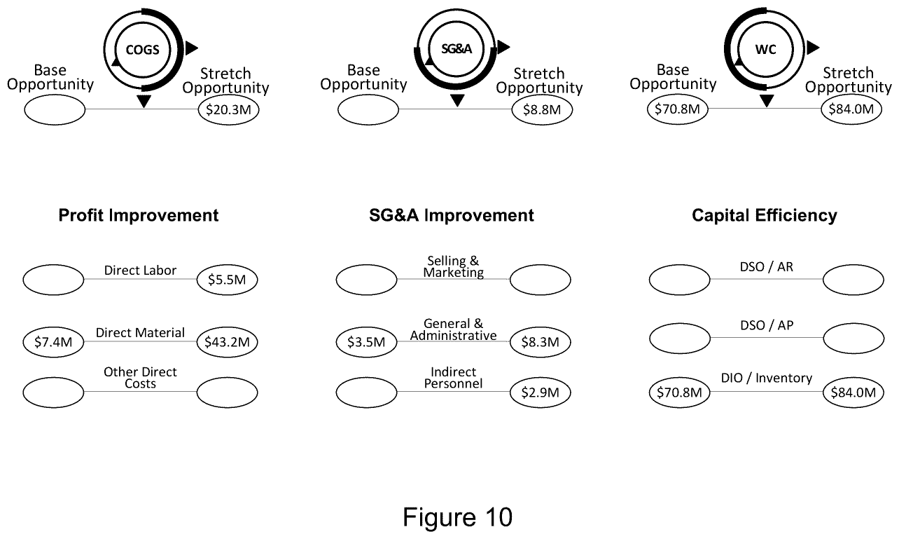

FIG. 10 is an example of an external opportunity summary, according to an embodiment of the present invention. Opportunity value may be estimated using a median and top quartile benchmarks from a peer set. Values presented in the Summary may be based on median benchmarks. In this example, Company A may operate in paper and plastic packaging. Peer set descriptions may include 18 or so companies in the paper and plastic packaging industry located in north America with a revenue less than a predetermined amount (e.g., $2.5B). With an embodiment of the present invention, key takeaways may include: performance improvement opportunity of $70.8M exist only in Working Capital when compared to peer median; and largest sub-metric opportunity levers exist within Days Inventory Outstanding of $84.0M compared to top quartile.

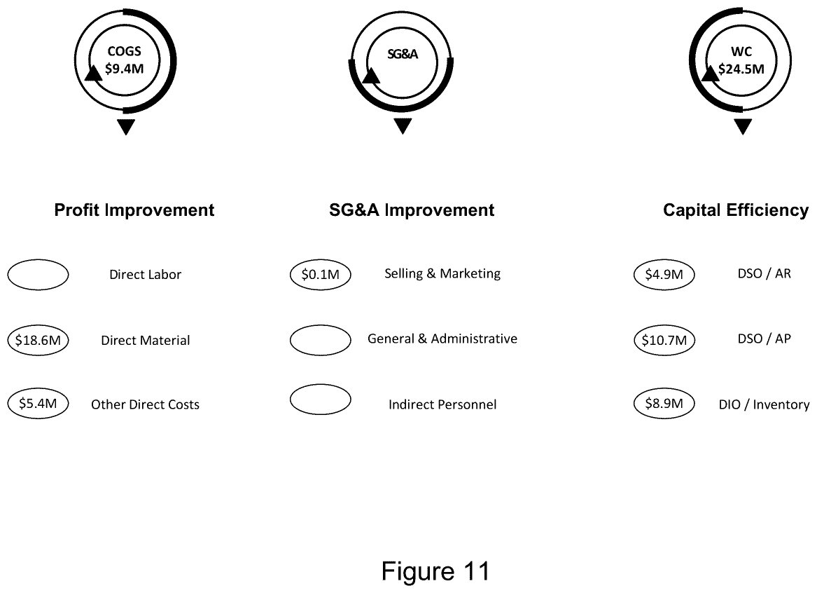

FIG. 11 is an example of an internal opportunity summary, according to an embodiment of the present invention. Internal best demonstrated opportunities may be calculated using the company's best historical performance. With an embodiment of the present invention, key takeaways may include: internal best opportunity on cost savings representing $9.4M in COGS and $24.5M opportunity in working capital compared to the historical best; and the largest sub-metric opportunity levers exist within Direct Material Cost of $18.6M.

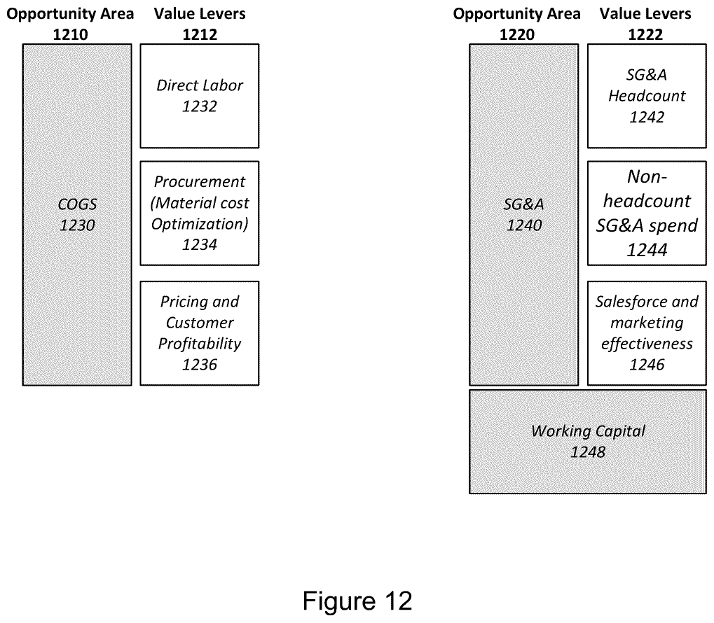

FIG. 12 illustrates opportunity area examples, according to an embodiment of the present invention. An embodiment of the present invention may identify an Opportunity Area 1210 as COGS 1230 with value levers 1212 of Direct Labor 1232, Procurement (material cost optimization) 1234 and Pricing and Customer profitability 1236. An embodiment of the present invention may recognize an approach to diligence for each value lever.

Direct Labor 1232 may involve: Building “bottoms-up” master employee database with salary and fringe benefits cost at the individual employee level using census and related files; Analyzing spans and layers for potential improvement (e.g., increasing supervisors' spans); understanding/comparing the mix of hourly and salaried employees across locations; assessing and benchmarking direct labor utilization to identify opportunity for improvement in labor utilization rates; analyzing employee turnover for number of skilled operators/technicians and man-hours trend on overall year-over-year basis; benchmarking overtime spend with respect to demand on yearly basis and across production lines depending on availability of overtime data and other performance KPIs, etc.

Procurement (material cost optimization) 1234 may involve: Creating consolidated raw material spend database with detailed master spend cube for materials/services and perform ‘best prices’ analysis across vendors; Performing analysis on vendor spend data to assess spend by type to identify potential volume discounts not currently utilized, duplicative vendors, as well as performing contract analysis to determine potential cost saving opportunities; Performing an analysis reviewing supplier contracts and sourcing to improve product quality issues and improve cost savings; and Assessing and identifying potential opportunity to optimize rebates/discounts for major/star vendors with significant volumes; etc.

Pricing and Customer profitability 1236 may involve: Understanding current pricing structure for the customers by segment/market; Conducting fully costed analysis to study the profitability at the contribution margin level and identify low profitability menu items for potential rationalization; Analyzing cost-to-serve by customer and product to identify unprofitable customers and products; Assessing pricing improvements, contract negotiations or rationalization of loss-making customers; Identifying reasons for customer loss through management interviews/customer reviews; Quantifying the impact of customer loss on the Revenue and EBITDA; etc.

An embodiment of the present invention may identify an Opportunity Area 1220 as SG&A 1240 with value levers 1222 of SG&A Headcount 1242; Non-Headcount SG&A Spend 1244; and Salesforce and Marketing Effectiveness 1246. An embodiment of the present invention may recognize an approach to diligence for each value lever. Working Capital may be identified as an Opportunity Area.

SG&A Headcount 1242 may involve: Performing organization headcount analysis to understand the org. structure and conduct functional headcount benchmarking within peer group or industry; Performing spans and layers analysis across different functions and levels; Assessing and analyzing reporting hierarchy at different levels, highlight any inconsistency in report relationships or wide variances in salary levels and compensation analysis; Identifying duplicate back-office roles across the organization; Performing a cost benefit analysis to assess efficiency and scalability of centralized back-office platforms if existing to save costs in full time employees (FTE); etc.

Non-Headcount SG&A Spend 1244 may involve: Analyzing back-office spend to identify major cost buckets and redundant spend to optimize non-people costs; Performing G&A (back-office) benchmarking analysis against industry peers to identify potential improvement opportunities for non-FTE spend; Identifying opportunities to consolidate backend functions through shared services centers; Preparing a detailed third-party spend cube to identify potential vendor consolidation, best price negotiation opportunity to arrive at optimized third party spend; etc.

Salesforce and Marketing Effectiveness 1246 may involve: Establishing framework to analyze ramp-up period performance, sales rep account relationships; historical performance and assess sales pipeline; Assessing sales rep performance by tenure segments and evaluate performance improvement opportunity for sales rep based on segment benchmarks; Analyzing current incentive compensation structure and relationship for sales team and newly hired sales reps; Assessing impact of new hires on incremental sales and benchmark performance; Measuring effectiveness of marketing campaigns at the channel level to identify low return on investment (ROI) channels and optimize customer acquisition cost across channels; etc.

Working Capital Opportunity 1248 may involve: Historical analysis of receivables & payables to understand Clients Payment behavior and Collection patterns; Increased payment terms with suppliers and reduced collection terms with customers is implemented to optimize the liquidity; Different methods like payment term harmonization, payment term reduction, modifying payment runs are implemented to optimize cash conversion cycle; Inventory optimization by calculating target stock at SKU level to meet demands without piling the excess inventory on shelves; Benchmarking of cash conversion cycles (e.g., DSO, DPO and DIO) as compared to Industry leaders and the peer group; Assess contracts to identify opportunities for a better term negotiation by comparing it with Industry standards; etc.

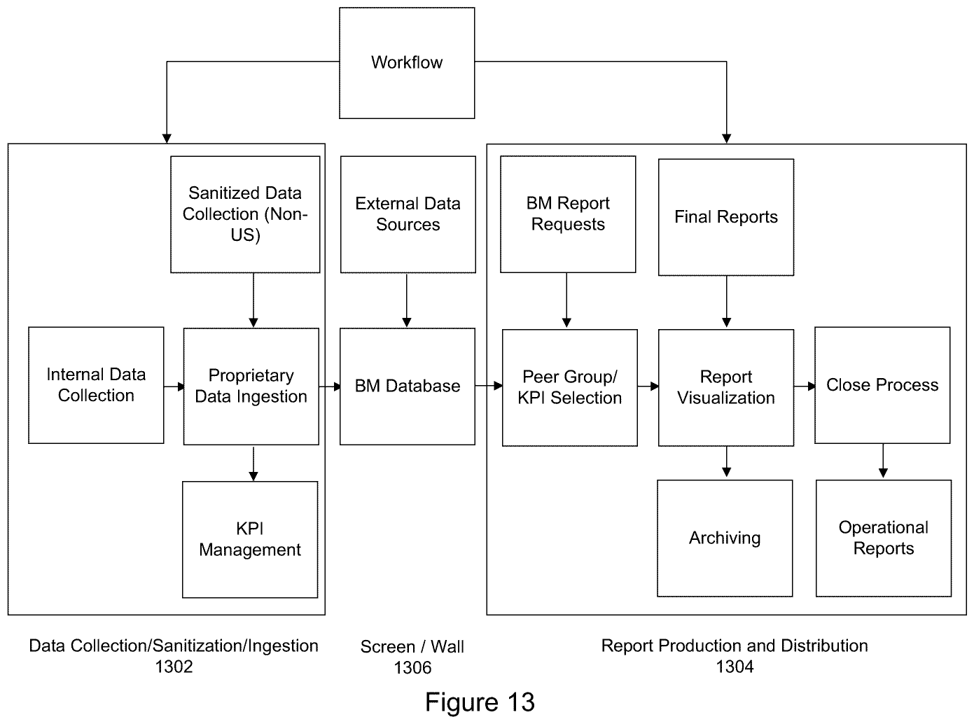

FIG. 13 is an exemplary process flow, according to an embodiment of the present invention. FIG. 13 illustrates a Risk approved benchmarking process designed to protect client confidentiality, while maintaining scale, insight and efficiency. The exemplary workflow includes Data Collection/Sanitization/Ingestion 1302 as well as Report Production and Distribution 1304, which are separated by a Screen/Wall 1306. While the process of FIG. 13 illustrates certain steps performed in a particular order, it should be understood that the embodiments of the present invention may be practiced by adding one or more steps to the processes, omitting steps within the processes and/or altering the order in which one or more steps are performed.

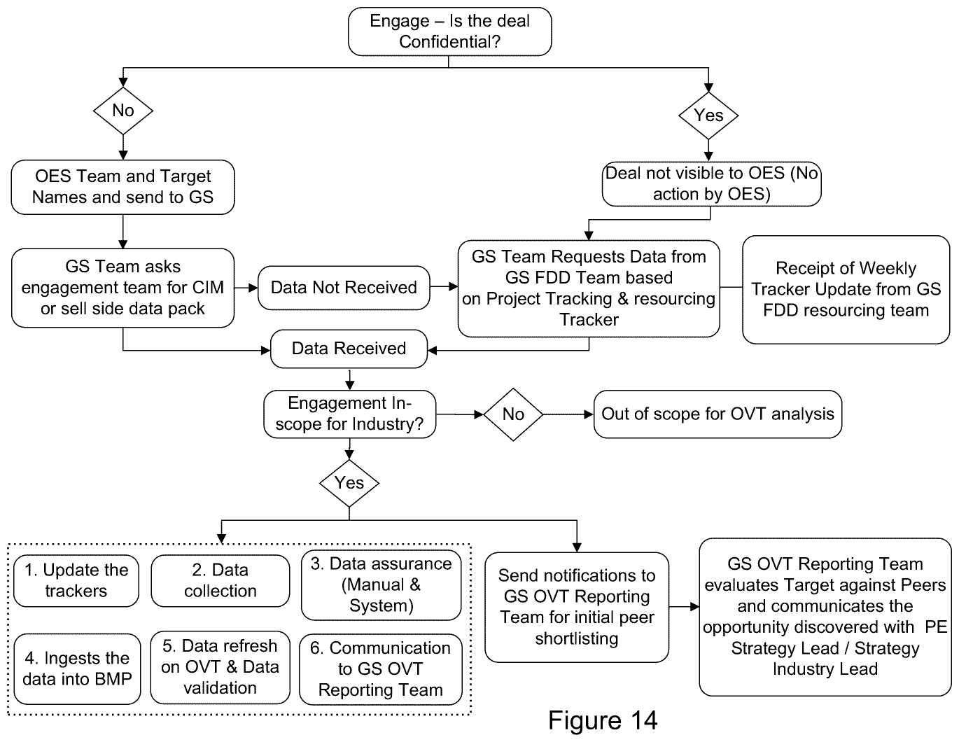

FIG. 14 is an exemplary process flow, according to an embodiment of the present invention. FIG. 14 illustrates a process flow for engagements. At engagement, a determination may be made as to whether the deal is confidential. If not, data may be retrieved. If the deal is confidential, data may be requested.

A determination may be made as to whether the engagement is in scope for an industry. If yes, a process may be applied that (1) updates the trackers; (2) collects data; (3) data assurance; (4) ingests data; (5) refreshes data and validates data; and (6) communicates to reporting team. Notifications may be sent to a reporting team for initial peer shortlisting. Reporting team may then evaluate targets against peers where opportunities may be communicated. As shown in FIG. 14, GS represents a global services business unit. OES represents Operations Engagement Setup, e.g., engagement setup within Deal, Advisory & Strategy (DAS)). While the process of FIG. 14 illustrates certain steps performed in a particular order, it should be understood that the embodiments of the present invention may be practiced by adding one or more steps to the processes, omitting steps within the processes and/or altering the order in which one or more steps are performed.

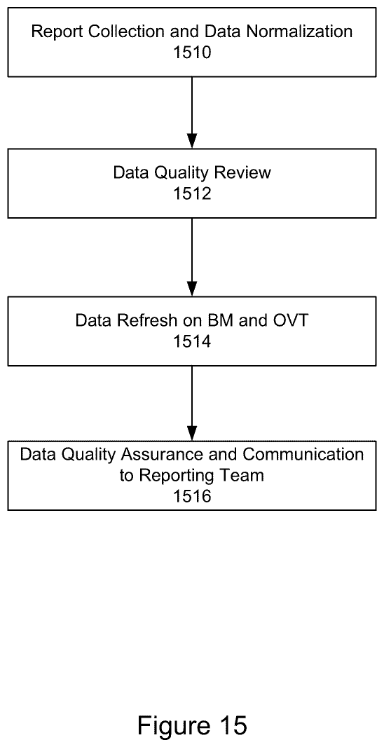

FIG. 15 is an exemplary process flow, according to an embodiment of the present invention. FIG. 15 illustrates an opportunity value process stage and key points. An embodiment of the present invention seeks to complete OVT engagement processing within a predetermined period of time (e.g., 24 hours) on receipt of reports. Step 1510 performs report collection and data normalization. Step 1512 performs a data quality review. Step 1514 performs a data refresh on benchmarking (BM) and opportunity value through OVT. Step 1516 performs data quality assurance and communication to a reporting team. While the process of FIG. 15 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

Step 1510 performs report collection and data normalization. This step may involve: in-scope industry checks; quick checks on Income Statement (IS), Balance Sheet (BS) & Quarter (Qtr.) data availability; retrieving shareholders confirmation on data gaps if any; assigning projects to analysts for data collection, etc. This step may also involve: verifying key data items and highlight any gaps; ensuring proper templates used for standard/Qtr. Data; completing data collection before a predetermined time (e.g., 2:30 PM (EST)) on the same day.

Step 1512 performs a data quality review. This step may involve: assigning projects for quality review. This step may also involve: detailed review and real-time fixes; highlight whether any data gaps/issues identified; finalize and upload the data before a predetermined time (e.g., 5 PM (EST)) on the same day; and confirm data for KPIs in a Company Performance Viewer by a predetermined time (e.g., 6 PM (EST)) on the same day. This may also involve quality control, such as running system-based checks using a workflow

Step 1514 performs a data refresh on benchmarking (BM) and opportunity value through OVT. The step may involve: ensuring BM data refresh; contacting a Development team if any tech issues; checking for OVT data refresh; contacting a Data Engineering Team for ad-hoc data refresh if scheduled refresh missed at a predetermined time (e.g., 6.30 PM (EST)) on the same day.

Step 1516 performs data quality assurance and communication to a reporting team. This step may involve: validating data on OVT dashboard and ensuring data consistency across multiple periods and addressing anomalies; creating a study on OVT by selecting peers from target industry, geography, and revenue range to compare; notifying a reporting team “The data is ready for Opportunity Analysis.”

According to an embodiment of the present invention, key data items for opportunity analysis may include a wide range of considerations relating to Income Statement; Balance Sheet; Cash Flow Statement; Operational KPIs, etc.

Income Statement data items may include: Total revenue; EBITDA; EBIT; EBT; Cost of goods sold (e.g., Direct labor costs; Direct material costs; Other direct cost (excl. labor & material)); selling, general and administration expenses (e.g., Selling & marketing expenses; general and administrative expenses; indirect labor cost); Advertising expenses; Professional fees; Rent expenses; Communication expenses; Travel and entertainment expenses; Training costs; Occupancy cost; Shipping & transportation expenses; Utilities expenses; Insurance expenses; Recruiting expenses; Research & development expenses; Other operating expenses; Depreciation & amortization; Income tax expense; Net income-Cont. Ops.; etc.

Balance Sheet data items may include: Accounts receivables; Inventory; Net property, plant & equipment; Accounts payables; Total assets; Total equity; etc.

Cash Flow Statement data items may include: capital expenditures. Operational KPIs data items may include: total employees, etc.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the system software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more of them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

1. The system comprises:
an input configured to access one or more data sources that store and manage target proprietary financial data and public data;
an interactive user interface that communicates with one or more user devices via a communication network; and
a computer processor coupled to the input, the interactive user interface and the one or more data sources, the computer processor further configured to:
identify, via the computer processor, a target entity;
perform, via the computer processor, a peer selection for the target entity by applying an optimal set of filters comprising industry, geographic region, time period, revenue, and EBITDA margin;
generate, via the computer processor, a target summary comprising at least a profit improvement opportunity and a working capital opportunity;
generate, via the computer processor, the profit improvement opportunity comprising analytics by EBITDA, cost of goods sold (COGS) and selling, general and administrative expenses (SG&A);
generate, via the computer processor, the working capital opportunity comprising analytics by Days Sales Outstanding (DSO), Days Payables Outstanding (DPO) and Days of Inventory Outstanding (DIO);
generate, via the computer processor, an opportunity strategy for the profit improvement opportunity and the working capital opportunity; and
execute, via the computer processor, the opportunity strategy for the target entity.

2. The system of claim 1, wherein the peer selection is further based on one or more prior engagements and public data.

3. The system of claim 1, wherein the profit improvement opportunity comprises one or more COGS opportunity that is further based on direct labor and direct material.

4. The system of claim 1, wherein the profit improvement opportunity comprises one or more SG&A opportunity that is further based on selling and marketing expenses, general and administrative expenses and indirect personal expenses.

5. The system of claim 1, wherein the analytics by EBITDA further comprises revenue, total cost, depreciation and amortization.

6. The system of claim 1, wherein the profit improvement opportunity comprises Cost Breakdown that is further based on COGS material and labor, SG&A labor and shared expenses.

7. The system of claim 1, wherein the working capital opportunity is based on revenue, industry and peers available.

8. The system of claim 1, wherein the working capital opportunity comprises at least one Days Sales Outstanding (DSO) opportunity that further comprises external opportunity, internal opportunity, and peer comparison.

9. The system of claim 1, wherein the working capital opportunity comprises at least one Days Payables Outstanding (DPO) opportunity that further comprises external opportunity, internal opportunity, and peer comparison.

10. The system of claim 1, wherein the working capital opportunity comprises at least one Days of Inventory Outstanding (DIO) opportunity that further comprises external opportunity, internal opportunity, and peer comparison.

11. A method comprises the steps of:
identifying, via a computer processor, a target entity;
performing, via the computer processor, a peer selection for the target entity by applying an optimal set of filters comprising industry, geographic region, time period, revenue, and EBITDA margin;
generating, via the computer processor, a target summary comprising at least a profit improvement opportunity and a working capital opportunity;
generating, via the computer processor, the profit improvement opportunity comprising analytics by EBITDA, cost of goods sold (COGS) and selling, general and administrative expenses (SG&A);
generating, via the computer processor, the working capital opportunity comprising analytics by Days Sales Outstanding (DSO), Days Payables Outstanding (DPO) and Days of Inventory Outstanding (DIO);
generating, via the computer processor, an opportunity strategy for the profit improvement opportunity and the working capital opportunity; and
executing, via the computer processor, the opportunity strategy for the target entity.

12. The method of claim 11, wherein the peer selection is further based on one or more prior engagements and public data.

13. The method of claim 11, wherein the profit improvement opportunity comprises one or more COGS opportunity that is further based on direct labor and direct material.

14. The method of claim 11, wherein the profit improvement opportunity comprises one or more SG&A opportunity that is further based on selling and marketing expenses, general and administrative expenses and indirect personal expenses.

15. The method of claim 11, wherein the analytics by EBITDA further comprises revenue, total cost, depreciation and amortization.

16. The method of claim 11, wherein the profit improvement opportunity comprises Cost Breakdown that is further based on COGS material and labor, SG&A labor and shared expenses.

17. The method of claim 11, wherein the working capital opportunity is based on revenue, industry and peers available.

18. The method of claim 11, wherein the working capital opportunity comprises at least one Days Sales Outstanding (DSO) opportunity that further comprises external opportunity, internal opportunity, and peer comparison.

19. The method of claim 11, wherein the working capital opportunity comprises at least one Days Payables Outstanding (DPO) opportunity that further comprises external opportunity, internal opportunity, and peer comparison.

20. The method of claim 11, wherein the working capital opportunity comprises at least one Days of Inventory Outstanding (DIO) opportunity that further comprises external opportunity, internal opportunity, and peer comparison.
